(19) United States
(12) Patent Application Publication
(10) Pub. No.: US 2006/0138788 A1
(43) Pub. Date: Jun. 29, 2006

(54) Escutcheon plate for mortise and tubular lock assemblies

(75) Inventors: Michael Winardi, Chino Hills, CA (US); Jeanette V. Bui, Irvine, CA (US)

Correspondence Address: CARLSON, GASKEY & OLDS, P.C., 400 WEST MAPLE ROAD, SUITE 350, BIRMINGHAM, MI, 48009, US

(73) Assignee: Newfrey LLC

(21) Appl. No.: 11/023,308

(22) Filed: Dec. 27, 2004

(51) Int. Cl. E05B 3/00

(52) U.S. Cl. 292/336.3

(57) ABSTRACT

A handleset assembly provides a universal escutcheon plate. The universal escutcheon plate is usable with both a mortise handleset assembly by a mortise thumbpiece which includes a uniquely shaped tailpiece to properly locate the mortise thumbpiece within a thumbpiece aperture of the universal escutcheon plate.

### BACKGROUND OF THE INVENTION

The present invention relates to a handleset assembly, and more particularly to a universal escutcheon plate and thumbpiece therefor.

Escutcheon plates for mortise handleset are different from escutcheon plates for tubular handlesets due to different door prep for mortise and tubular lock assemblies. Due to the different design, the location and size of the thumbpiece aperture on the tubular escutcheon is different from that of the mortise, which requires the manufacturer to make a different escutcheon plate for each lock type even when the style is identical. The expense associated with manufacturing for each style as well as logistics and supply chain complexities may be relatively significant.

Accordingly, it is desirable to provide a universal escutcheon plate for use with both a tubular and mortise handleset assembly.

### SUMMARY OF THE INVENTION

A handleset assembly according to the present invention provides a universal escutcheon plate with which only a mortise thumbpiece, and a mortise thumbpiece mounting bracket needs to be changed out with a tubular thumbpiece and a tubular thumb cartridge to effect the changeover with the universal escutcheon plate as a generally rectilinear thumbpiece aperture is in a common vertical location relative to a lock aperture. A mortise thumbpiece includes a uniquely shaped tailpiece to properly locate the mortise thumbpiece within the thumbpiece aperture of the universal escutcheon plate.

The present invention therefore provides a universal escutcheon plate for use with both a tubular and mortise handleset assembly.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is an exploded view of a mortise handleset assembly;

FIG. 1B is a perspective view of the mortise handleset assembly of FIG. 1A;

FIG. 2A is an exploded view of a tubular handleset assembly;

FIG. 2B is a perspective view of the tubular handleset assembly of FIG. 1A;

FIG. 3A is a sectional view of a mortise handleset assembly;

FIG. 3B is a sectional view of a tubular handleset assembly;

FIG. 3C is an expanded perspective view of a tubular thumbpiece;

FIG. 3D is an expanded perspective view of a mortise thumbpiece; and

FIG. 4 is an expanded side view of a mortise thumbpiece.

### DETAILED DESCRIPTION OF THE PREFERRED EMBODIMENT

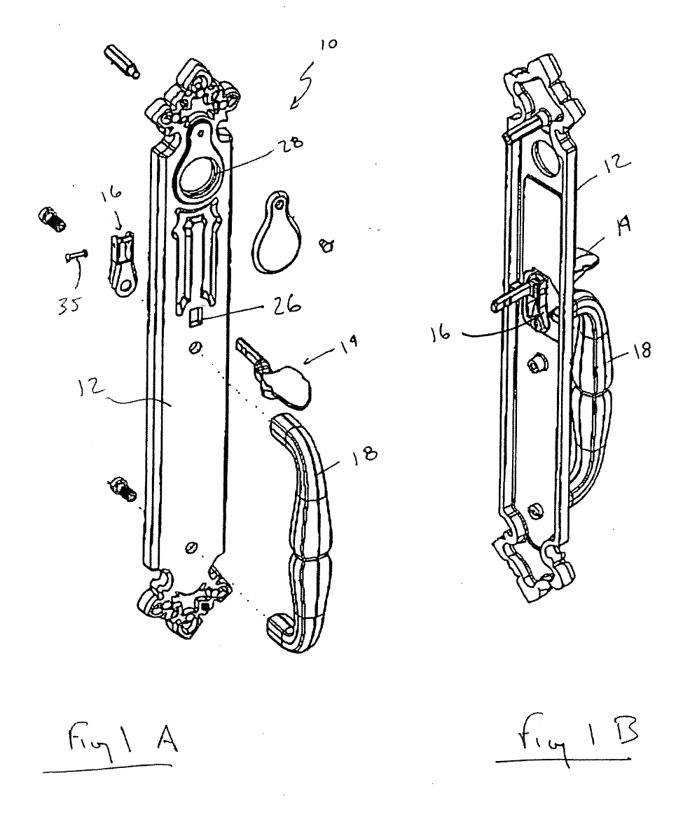

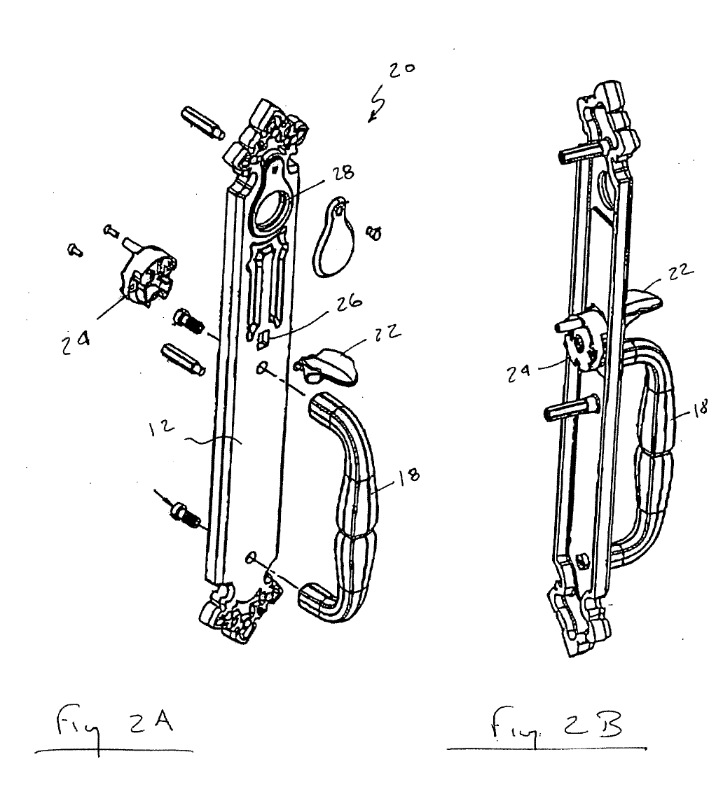

FIG. 1A illustrates an exploded view of a mortise handleset assembly 10 (FIG. 1B). The mortise handleset assembly 10 generally includes a universal estruncheon plate 12, a mortise thumbpiece 14, a mortise thumbpiece mounting bracket 16 and a handle 18.

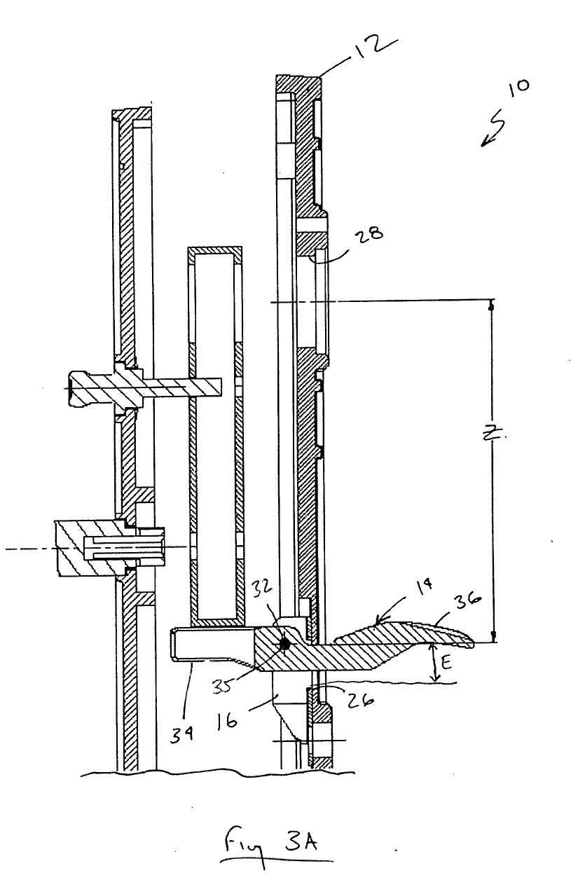

Referring to FIG. 2A, an exploded view of a tubular handleset assembly 20 (FIG. 2B) is illustrated. The tubular handleset assembly 20 generally includes the universal escutcheon plate 12, a tubular thumbpiece 22, a tubular thumb cartridge 24 and the handle 18. Notably, the universal escutcheon plate 12 is the same in both the mortise handleset assembly 10 and the tubular handleset assembly 20.

Commonality of the universal escutcheon plate 12 reduces expense and inventory considerations related to the handleset assemblies 10, 20. It should be understood that although only a particular architectural style is illustrated in the disclosed embodiment, other architectural styles such as Tuscany, French, Craftsman will also benefit from the present invention. That is, any style will utilize the same casting for exterior escutcheon plate whether it's a tubular or mortise application.

Only the mortise thumbpiece 14, and the mortise thumbpiece mounting bracket 16 needs to be changed out with the tubular thumbpiece 22 and the tubular thumb cartridge 24 to effect the changeover with the universal escutcheon plate 12 as a generally rectilinear thumbpiece aperture 26 (FIGS. 1A and 2A) is in a common vertical location relative to a lock cylinder aperture 28. It should be understood that other components such as the handle 18 are also include the same components in both handleset assemblies 10, 20 while other lock components dedicated to either the mortise or the tubular handleset assembly 10, 20 may also be particular thereto as generally understood.

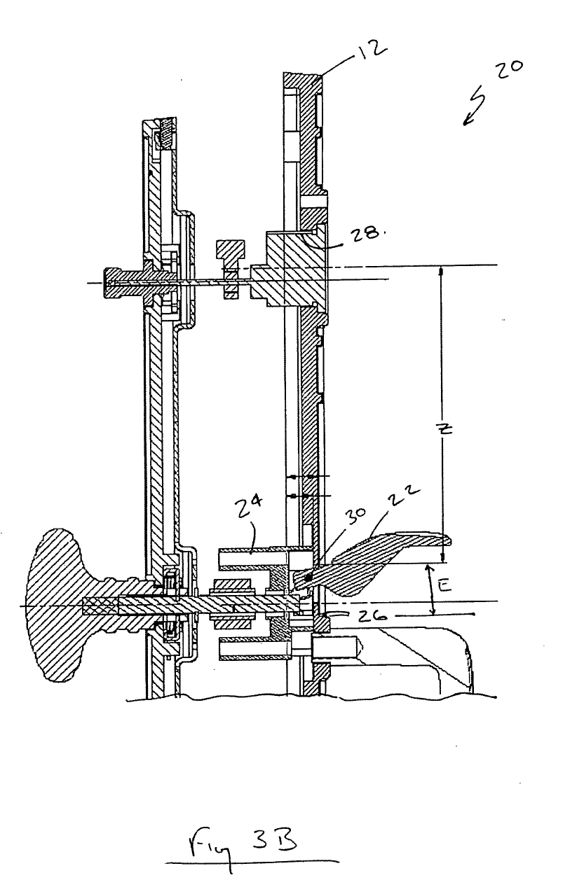

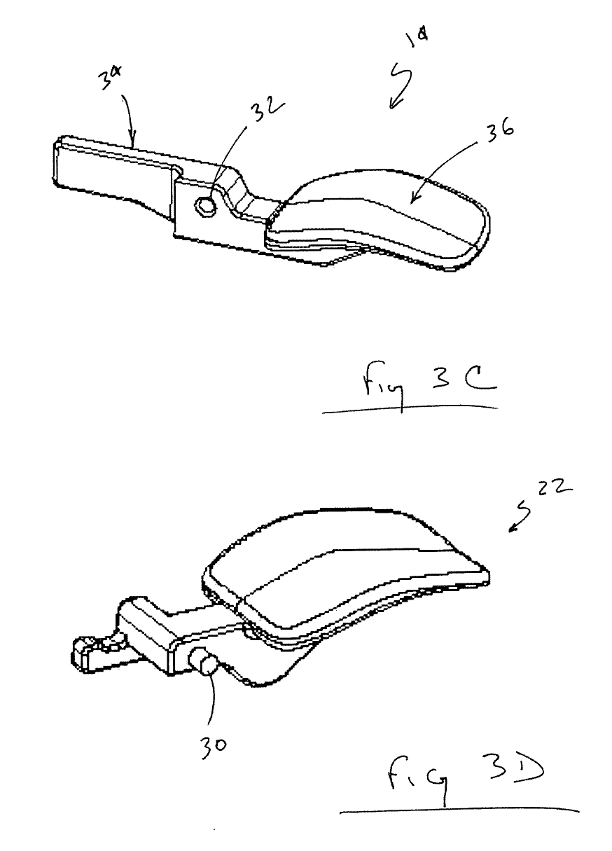

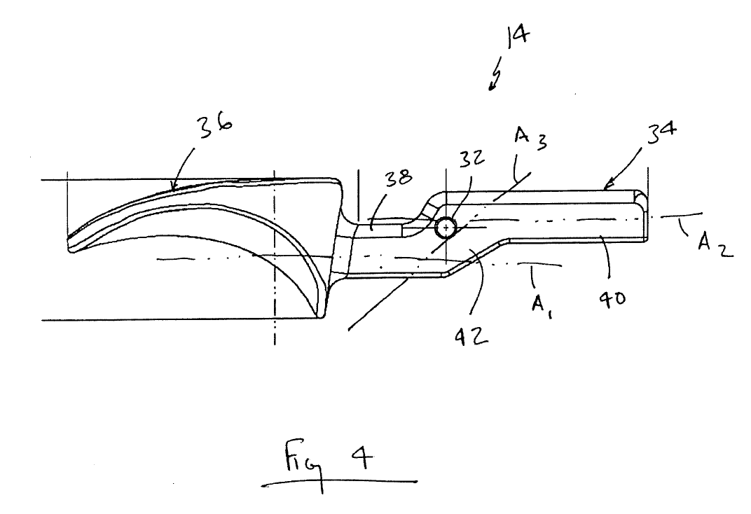

Referring to FIGS. 3A and 3B, the handleset assemblies 10, 20 are illustrated in cross-section to illustrate the location of the thumbpiece aperture 26. The thumbpiece aperture 26 is located a vertical distance Z from the lock cylinder aperture 28 such that either the mortise thumbpiece 14, and the mortise thumbpiece mounting bracket 16 or the tubular thumbpiece 22 and the tubular thumb cartridge 24 may be mounted on either side thereof.

The tubular thumbpiece 22 includes a pivot pin 30 (also illustrated in FIG. 3C) which engages the tubular thumb cartridge 24 to latch and unlatch a door with a tubular lock as generally understood. The pivot pin 30 is located a distance Z from a centerline of the lock cylinder aperture 28 such that the tubular thumbpiece 22 operates within a vertical envelope E defined by the thumbpiece aperture 26. The mortise thumbpiece 14 defines a pivot aperture 32 (also illustrated in FIG. 3D) to pivotally mount the thumbpiece 14 into the mortise thumbpiece mounting bracket 16 with a rivet 35 (also illustrated in FIG. 1A) to latch and unlatch a door with a mortise lock as generally understood. The pivot aperture 32 is likewise located the distance Z from the centerline of the lock cylinder aperture 28 such that the mortise thumbpiece 14 operates within the vertical envelope E defined by the thumbpiece aperture 26.

The pivot aperture 32 is not located within the vertical envelope E. A jogged tailpiece 34 extending from a thumbpad 36 of the mortise thumbpiece 14 permits operation with the thumbpiece aperture 26. The jogged tailpiece 34 of the mortise thumbpiece 14 must engage a bottom face of a lift lever on the mortise lock, which has heretofor been located at the same vertical distance, measured from the centerline of the lock cylinder aperture 28 as that of the top surface of a conventional straight mortise thumbpiece tail end. In the present invention, the distance Z from the centerline of the lock cylinder aperture 28 to the top edge of the thumbpiece aperture 26 is standardized to one location for both mortise and tubular escutcheons plates 12. As a result of this, the distance Z from centerline of the lock cylinder aperture 28 to the top edge of the thumbpiece aperture 26 is now different from that of the bottom face of the lift lever on the mortise lock. Since the lift lever location on a mortise lock is fixed, the solution to this is made possible by designing the uniquely shaped jogged tailpiece 34 for the mortise handleset 10.

Referring to FIG. 4, the mortise thumbpiece 14 includes the thumbpad 36 and the jogged tailpiece 34. The jogged tailpiece 34 includes a first tailpiece portion 38 extending from the thumbpad 36, a second tailpiece portion 40, and a jogged tailpiece portion 42 between the first tailpiece portion 38 and the second tailpiece portion 40. The first tailpiece portion 38 defines a first axis A1, the second tailpiece portion 40 defining a second axis A2 parallel and offset from said first axis A1 and the jogged tailpiece portion 42 defines a third A3 axis transverse to the first axis A1 and the second axis A2. The pivot aperture 32 is located between the axes A1, A2 and within the jogged tailpiece portion 42. It should be understood that although a particular offset or “jog” provides the universality of the present invention, other offsets or “jogs” will also be usable with the present invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A handleset assembly comprising:
an escutcheon plate having an aperture; and
a thumbpiece having a tailpiece which extends through said aperture, said tailpiece including a first tailpiece portion parallel and offset from a second tailpiece portion.

2. The handleset assembly as recited in claim 1, wherein said first tailpiece portion extends from a thumb pad.

3. The handleset assembly as recited in claim 1, wherein said tailpiece defines a pivot point along said second tailpiece portion.

4. The handleset assembly as recited in claim 3, wherein said pivot point is defined adjacent outside an envelope defined by said aperture.

5. The handleset assembly as recited in claim 1, wherein said second tailpiece portion engages a mortise lock assembly.

6. The handleset assembly as recited in claim 1, wherein said aperture is generally rectilinear.

7. The handleset assembly as recited in claim 1, wherein a first distance includes a first end and a second end, said first end beginning at a centerline of a lock cylinder for a tubular lock assembly mountable to said escutcheon plate and a centerline of a lock cylinder for a mortise lock assembly mountable to said escutcheon plate such that said second end falls within an envelope defined by said aperture.

8. A thumbpiece for a mortise handleset assembly comprising:
a thumbpad portion;
a first tailpiece portion extending from said thumbpad portion, said first tailpiece portion defining a first axis;
a second tailpiece portion defining a second axis parallel and offset from said first axis; and
a jogged tailpiece portion between said first tailpiece portion and said second tailpiece portion, said jogged tailpiece portion defining a third axis transverse to said first axis and said second axis.

9. The thumbpiece as recited in claim 8, further comprising a pivot point defined along said jogged tailpiece portion.

10. The thumbpiece as recited in claim 9, wherein said pivot point is between said first axis and said second axis.

11. The thumbpiece as recited in claim 8, wherein said thumbpad portion defines an upper thumbpad surface generally parallel to said first axis and said second axis.

12. The thumbpiece as recited in claim 11, wherein said first tailpiece portion is offset from said upper thumbpad surface.
